(19) United States
(12) Patent Application Publication
(10) Pub. No.: US 2022/0333991 A1
(43) Pub. Date: Oct. 20, 2022

(54) DETECTOR DEVICE AND METHOD FOR THE REMOTE ANALYSIS OF MATERIALS, AND MOBILE SENSOR SYSTEM

(71) Applicant: DEUTSCHES ZENTRUM FÜR LUFT- UND RAUMFAHRT E.V., 51147 Köln (DE)

(72) Inventors: Christoph KÖLBL, Neudenau (DE); Frank DUSCHEK, Königheim (DE)

(73) Assignee: DEUTSCHES ZENTRUM FÜR LUFT- UND RAUMFAHRT E.V., 51147 Köln (DE)

(21) Appl. No.: 17/641,873

(22) PCT Filed: Sep. 8, 2020
(86) PCT No.: PCT/EP2020/075097

§ 371 Date: Mar. 10, 2022

(30) Foreign Application Priority Data
Sep. 12, 2019 (DE) 10 2019 124 547.8

(51) Int. Cl. G01J 3/44; G01J 3/02; G01J 3/10; G01N 21/65; G01S 17/88; G01J 3/12

(52) U.S. Cl. CPC G01J 3/4412; G01J 3/0208; G01J 3/10; G01N 21/65; G01S 17/88; G01J 3/1256; G01J 2003/1247

(57) ABSTRACT

A detector device for the remote analysis of materials, in particular hazardous materials, including at least one laser, which is designed to emit pulsed laser light onto a sample located at a detection distance, and a telescope, which is designed to collect and/or focus laser light scattered on the sample and to forward the scattered laser light into an optical spectrometer. The optical spectrometer is designed for a spectral analysis of the laser light scattered on the sample. The laser is followed by a first beam path with a first reference beam and an additional beam path with a second reference beam for the scattered laser light. A unit is provided for determining a time difference between pulses of the first reference beam and pulses of the second reference beam, wherein the detection distance can be determined from the time difference. The unit is designed to determine the detection distance in real-time.

### BACKGROUND AND SUMMARY

The invention relates to a detector device for remote analysis of substances, in particular hazardous substances, and a mobile sensor system with a detector device, as well as a method for remote analysis of substances, in particular hazardous substances.

Laser-based technologies, such as LIDAR (Light Detection And Ranging) or stand-off detection systems, among others, are used for contactless measurement of hazardous substances over large distances of several meters to kilometers. In this context, LIDAR systems are mainly used to detect aerosols in the atmosphere in order to determine physical-state parameters in a spatially resolved manner with a high level of sensitivity. Although selectively sensitive systems are also found, e.g., Raman LIDAR or Differential Absorption LIDAR, the use of such systems is usually limited to atmospheric measurements, due to the laser wavelengths and laser-pulse energies used and system size.

In contrast, so-called stand-off detection will detect released solid or liquid chemical or biological substances/hazardous materials, e.g., on surfaces. Laser-based systems based on Raman spectroscopy are also used for this purpose. The advantage of this technique is that high selectivity is achievable, since it is based on the excitation of different molecular vibrations. However, long measurement times in the seconds range, high laser powers and/or correspondingly large receiving optics are required for a sufficiently large signal-to-noise ratio. Under laboratory conditions, these aspects do not present a problem. However, under real conditions, the boundary conditions are determined by this scenario. Current Raman systems are therefore only to a very limited extent suitable for the detection of hazardous substances. For example, measurement times are currently too long in order to perform hazardous material detection on objects, which move past the detection system at high speed.

DE 10 2016 121 517 A1 discloses a detection device, which comprises an optical detection device and an examination device, wherein the optical detection device has at least one camera, which optically detects a specified detection area of a moving object to be examined within a defined spatial control area. The examination device includes a spectroscopy device for spectroscopic examination of the detection area. The examination device has a tracking device, whereby the spectroscopy device spatially tracks a position of the detection area of the moving object.

The examination device further comprises an evaluation device, which evaluates data recorded by the spectroscopy device. Chemical substances, which are located on a surface of the detection area of the moving object, can be detected by means of spectroscopic examination.

It is desirable to create a detector device for the remote analysis of substances, which enables short measurement times with low susceptibility to interference.

It is also desirable to create a mobile sensor system with a detector device, which enables short measurement times with low interference susceptibility.

It is also desirable to specify a method for remote analysis of substances using such a detector device.

According to one aspect of the invention, a detector device is proposed for remote analysis of substances, in particular hazardous substances, comprising at least one laser adapted to irradiate pulsed laser light onto a sample located at a detection distance, and a telescope adapted to collect and/or focus laser light scattered from the sample and transmit the scattered laser light into an optical spectrometer.

The optical spectrometer is designed for spectral analysis of the laser light, which is scattered on the sample. The laser is followed by a first beam path with a first reference beam and another beam path with a second reference beam for the scattered laser light. A unit for determining a time difference between pulses of the first reference beam and of the second reference beam is provided, wherein the detection distance can be determined from the time difference. The unit is designed to determine the detection distance in real time based on the time difference.

A prior-art detector device for remote detection of hazardous materials by way of Raman scattering usually comprises a narrow-band CW laser source, less commonly a pulsed laser source with a low repetition rate, which emits laser radiation in the UV, VIS or NIR range. A beam adjustment unit is usually used to modify the laser mode according to the requirements of the measurement. The laser radiation is directed onto the sample via a decoupling mirror. The photons scattered elastically and inelastically by the sample are collected and focused by a receiving telescope and then pass through another beam-adjusting unit, such as an optical fiber, in order to couple the scattered laser light into a spectrometer. There, the laser light is spectrally dispersed and analyzed using a dispersive or diffractive element.

In contrast, the detector device according to an aspect of the invention has an extended detection system. The introduction of a unit for determining the time difference, e.g., a reference unit that processes the signals from two reference beams, results in several significant advantages compared to the prior art.

Advantageously, the system may be compact and can measure the sample with a short measuring period and high sensitivity.

The detection distance can be deteli lined in real time via the reference beams without an additional LIDAR system. This is a considerable advantage, especially in mobile applications, where the distance between the detector device and the sample may change and cannot be measured directly.

This makes possible an automated, variable setting of a trigger point depending on the detection distance in the case of detecting with a gating window. This allows for analyzing only one measurement window, in which corresponding information is expected.

Interfering radiation, e.g., from sunlight or an illumination source, which may contribute to offset the signal and thus reduce the usable dynamic range of the detector, can be efficiently suppressed.

The detector device enables shorter detection times with increased signal-to-noise ratio compared to the prior art.

With the detector device according to an aspect of the invention, the most important individual detection parameters, such as measurement time, laser pulse energy, size of the detection optics, signal-to-noise ratio, can be substantially improved. This will enable the construction of a Raman system for a real-life scenario. The measurement time can be kept as short as possible, e.g., for detection of moving objects.

It is sufficient to use a low laser pulse energy to ensure the safety of persons involved. The detection optics can be made spatially small, which has an impact on the size of the system. All this can be achieved while maintaining maximum signal-to-noise ratio, which is important for the sensitivity of the system.

The detector device is advantageously suited for detecting hazardous substances with rapid assessment of the hazardous situation. In real-life scenarios, it is often the case that leaked substances are not known and the risk potential can initially only be estimated. The detector device according to an aspect of the invention makes it possible to very quickly provide initial information for assessing a hazard. Furtheli lore, the extent of contamination can easily be determined. With a classic state-of-the-art point detector, the sample location must be scanned virtually point by point. For measuring times greater than Is, this takes a correspondingly long time. The measurement times with the present system are considerably shorter, such that the propagation can also be recorded. This can even be done contactlessly, due to the stand-off configuration.

According to an advantageous embodiment of the detector device, the unit, e.g., the reference unit, may be designed for power calibration with each emitted laser pulse and/or, in the case of multispectral excitation, intensity calibration at multiple laser wavelengths.

According to an advantageous embodiment of the detector device, a first decoupling mirror for decoupling a first reference beam into a first detector can be provided in the beam path of the emitted laser light, and a second decoupling mirror for decoupling a second reference beam into a second detector can be provided in the beam path of the scattered laser light.

According to an advantageous embodiment of the detector device, the second decoupling mirror can be designed as a beam splitter, in particular a dichroic beam splitter, whereby laser light elastically scattered by the sample can be decoupled separately from inelastically scattered Raman light and fluorescence light into the beam path of the second reference beam. The time of arrival of the elastically scattered laser light on the second detector also serves as a variable trigger for starting the spectral analysis in the spectrometer. The advantage of this arrangement is that the trigger time for analysis in the spectrometer can automatically shift in time according to the change in distance between the detector device and the sample.

According to an advantageous embodiment of the detector device, the laser may be designed with a maximum wavelength of 400 urn and/or a pulse repetition rate in the 1 kHz-10 MHz range, in particular up to 1 MHz and/or a maximum pulse width of 10 ns. The greater the pulse repetition rate, the faster the spectrum can be acquired. This means that moving objects can also be detected. The pulse width is typically in the nanosecond range. To ensure that the distance to the specimen can be reliably determined, the laser pulse should preferably have as steep a rising edge.

According to an advantageous embodiment of the detector device, a first adjustment optics, in particular with a bandpass filter, may be provided in the beam path of the first reference beam. Thus, a suitable optical unit can be used to suppress any interfering signals not oriainating from the laser, e.g., by means of bandpass filters around the central wavelength of the laser. The filtered laser light can then be focused onto a fast photodiode, as the first detector.

According to an advantageous embodiment of the detector device, a second adjustment optics, in particular with a bandpass filter and/or a focusing unit, may be provided in the beam path of the second reference beam. With the aid of the second adjustment optics, which may include a bandpass filter around the central wavelength of the laser and a lens, the spectrally cleaned, backscattered laser light can be focused on a second fast photodiode, as a second detector.

According to an advantageous embodiment of the detector device, the spectrometer may comprise at least a filter module, a detector, and a measuring unit. By means of the filter module, the scattered laser light can be processed for spectral decomposition, such that it can be detected with high sensitivity in the detector. The measuring unit is used to display the detector readout and convert the analog measuring signal into a digital signal.

According to an advantageous embodiment of the detector device, the filter module may be designed as a tunable filter, and/or the detector as a point sensor or an imaging sensor, and/or the measuring unit with boxcar averaging of measured values.

Using a tunable filter, whose filter curve can be shifted over the spectrum, signals with high sensitivity can be determined. Point sensors can be used as very sensitive, fast detectors. In contrast, imaging sensors allow for spatial detection of the sample environment. Boxcar averaging can be used advantageously in order to suppress interfering background radiation.

According to an advantageous embodiment of the detector device, a beam adjustment unit may be provided in the beam path of the laser light prior to decoupling onto the sample via a third decoupling mirror. In the beam adjustment unit, for example, a beam diameter and/or a divergence of the laser light can be adapted to the desired measurement task and/or the detection distance.

According to an advantageous embodiment of the detector device, a beam adjustment unit, in particular having a filter unit, may be provided in the beam path of the scattered laser light after the telescope. For example, the beam adjustment unit may include coupling into an optical fiber, due to the spatial separation of the telescope and the detection optics. In the filter unit, the backscattered laser light may be suitably conditioned for detection and freed from interfering background.

According to an advantageous embodiment of the detector device, the telescope may be designed with an autofocus unit. In particular, the autofocus unit may be controlled by determining the detection distance. By using an autofocus unit for telescope control, advantageous coupling efficiency can be achieved, when imaging the scattered laser light from the telescope onto the following beam adjustment unit.

According to an advantageous embodiment of the detector device, a reference unit for processing signals of the first and second detector may be designed, whereby the measuring unit, and/or the filter module, and/or the autofocus unit can be controlled.

The reference unit determines a signal propagation time for the laser pulses and the corresponding trigger times. This allows the measuring unit and/or the filter module and/or the autofocus unit to receive control signals in a suitable manner.

According to an advantageous embodiment of the detector device, a control unit can be provided with which, emission of individual laser pulses can be controlled. The control unit can be appropriately triggered via an input on a computer connected thereto, and thus initiate the start of a measurement. It can also be used to trigger the emission of individual laser pulses for specific measurement tasks.

According to another aspect of the invention, a mobile sensor system for remote analysis of substances, in particular hazardous substances, is proposed, comprising an unmanned ground vehicle or aerial vehicle, in particular a drone, with a detector device. In this case, the detector device is arranged in a housing which is connected, in particular detachably connected, to the ground vehicle or aircraft.

The mobile sensor system advantageously realizes an integration of the detector device for remote analysis of substances, in particular hazardous substances, into an unmanned ground vehicle or air vehicle, in particular a drone, which can be controlled autonomously or by a remote user.

With such a mobile sensor system, detection of in particular hazardous substances can be carried out from a spatial distance without endangering persons.

This can be used, e.g., to inspect buildings, equipment, vehicles, aircraft and other man-made or natural surfaces for the presence of unknown substances or hazardous materials, such as explosive materials. The advantage is that this makes it possible to search for or detect such hazardous substances without the need for the onsite presence of people. Compact installation of the detector device in a suitable housing makes it easy to transport and maintain the mobile sensor system.

According to a further aspect of the invention, a method for remote analysis of substances, in particular hazardous substances, with a detector device is proposed. The method comprises at least the steps of (i) irradiating pulsed laser light onto a sample located at a detection distance; (ii) decoupling and detecting a first reference beam in a first detector; (iii) collecting and/or focusing laser light scattered from the sample in a telescope; (iv) decoupling and detecting a second reference beam in a second detector; (v) determining the detection distance in real time from a time difference between pulses of the first reference beam and pulses of the second reference beam; (vi) forwarding the scattered laser light to an optical spectrometer; (vii) performing a spectral analysis of the laser light scattered from the sample in the spectrometer; and (viii) classifying the analyzed laser light, in particular classifying the analyzed laser light according to substance classes.

A significant advantage of the method according to an aspect of the invention is the determination of the detection distance in real time without an additional LIDAR system. By using a pulsed laser system, whose laser pulses have a steep rising edge, the detection distance to the sample can be determined directly with the aid of the first and second detectors by measuring the time delay between emission and re-arrival of the laser pulse via a laser propagation measurement.

The time of arrival of the elastically scattered laser light on the second detector serves as a variable trigger for the spectrometer. The advantage of this arrangement is that the trigger time automatically shifts in time according to the change in distance between the detection system and the sample. With this detection via a so-called gating window, only the measurement window, in which a signal is also to be expected, is analyzed.

Interfering light signals, which provide a continuous background and lower both the usable dynamic range of the detector and the signal-to-noise ratio, can be suppressed, egg by means of bandpass filtering and/or a boxcar averaging of the measurement signals, which enables sliding averaging of signals, in particular in order to suppress an interfering background under the measurement signal.

With these advantages, the method according to an aspect of the invention enables shorter detection times with an increased signal-to-noise ratio compared to the prior art.

According to an advantageous embodiment of the method, a power calibration may be performed and/or, if the pulsed laser light comprises multiple laser wavelengths, an intensity calibration of the pulsed laser light may be performed. This can preferably be done between steps (v) and (vi). In this case, the detector voltages supply further information. After an initial calibration, the two detectors can be calibrated relative to one another in order to obtain further information about the sample and its scattering properties.

According to an advantageous embodiment of the method, elastically scattered laser light, which is separated from inelastically scattered Raman light and fluorescence light via the second decoupling mirror as a beam splitter, in particular as a dichroic beam splitter, can be decoupled as a second reference beam into the second detector. The time of arrival of the elastically scattered laser light on the second detector also serves as a variable trigger for the start of the spectral analysis in the spectrometer. The advantage of this arrangement is that the trigger time automatically shifts in time according to the change in distance between the detection system and the sample.

According to an advantageous embodiment of the method, for performing the spectral analysis, the scattered laser light can be filtered by means of a narrowband filter, in particular a notch filter, and/or a wavelength range can be selected by means of a tunable filter, in particular a narrowband tunable filter.

A narrowband notch filter is advantageously used to block out a specific interfering frequency in a broader frequency spectrum. By means of an especially narrowband tunable filter whose filter curve can be tuned over the spectrum, signals with high sensitivity can be determined.

According to an advantageous embodiment of the method, laser light with a maximum wavelength of 400 nm and/or a pulse repetition rate in the 1 kHz to 10 MHz range, in particular up to 1 MHz, and/or a maximum pulse width of 10 ns can be used. The greater the pulse repetition rate, the faster the spectrum can be acquired. The pulse width is typically in the nanosecond range. For the distance to the sample to be determined, the laser pulse should have a steep rising edge, if possible.

According to an advantageous embodiment of the method, the first reference beam can be filtered and/or focused in front of the first detector via a first adjustment optics, in particular with a bandpass filter. This may suppress or at least reduce interfering background or other interfering signals.

According to an advantageous embodiment of the method, the second reference beam can b5e filtered and/or focused upstream of the second detector via a second adjustment optics, in particular with a bandpass filter. Thus, a suitable optical unit may be used to suppress any interfering signals, which do not originate from the laser, e.g., by means of bandpass filters around the central wavelength of the laser.

According to an advantageous embodiment of the method, interfering signals in the scattered laser light may be eliminated in the spectrometer, in particular in a separate measuring unit, with boxcar averaging of the measured values. Boxcar averaging of measured values allows moving averaging of signals and may be used favorably for the elimination of interfering background signals.

According to an advantageous embodiment of the method, a divergence and/or a diameter of the laser beam can be adjusted by means of a beam adjustment unit before being decoupled onto the sample via a third decoupling mirror. Beam diameter and/or divergence of the laser light can thus be conveniently adapted to the desired measurement task and/or detection distance.

According to an advantageous embodiment of the method, a wavelength range of the scattered laser light in the beam path after the telescope can be selected by means of a beam adjustment unit, in particular with a filter unit. In particular, focusing of the scattered laser light in the beam path from the telescope toward the beam adjustment unit can be controlled with an autofocus unit, especially by determining the detection distance. Furthermore, in particular the measuring unit, and/or the filter module, and/or the autofocus unit can be controlled in a reference unit via the processing of signals of the first and second detector. Using the method according to an aspect of the invention, the control of the detector device can be adapted and controlled in a suitable manner to a desired measurement task. The individual components of the system act largely autonomously with respect to one another, such that even remote analysis of substances can take place, preferably in an automatically control led manner.

According to an advantageous embodiment of the method, the start of a remote analysis and thus transmission of individual laser pulses can be controlled by means of a control unit, in particular following input to a computer. By means of the control unit, a measuring task can be started manually, via computer input, or automatically, e.g., at preselected times.

According to another aspect of the invention, a software product is proposed comprising instructions which, when the program is executed by a computer, cause the computer perform the method according to an aspect of the invention.

### BRIEF DESCRIPTION OF THE DRAWINGS

Further advantages result from the following description of the drawing. The figures show examples of embodiments of aspects of the invention. The figures, description and claims contain numerous features in combination. A person skilled in the art will advantageously also consider the features individually and combine them into useful further combinations.

FIG. 1 a schematic structure of components of a detector device for remote analysis of substances according to an exemplary embodiment of an aspect of the invention;

FIG. 2 a schematic structure of an overall system of a detector device according to a further exemplary embodiment of an aspect of the invention;

FIG. 3 a signal waveform over time of a method for remote analysis of substances according to an exemplary embodiment of an aspect of the invention;

FIG. 4 typical calibration curves of the first and second detectors of the detector device;

FIG. 5 an example of the implementation of boxcar averaging for the method according to an exemplary embodiment of an aspect of the invention;

FIG. 6 an example of scanning the scattered laser spectrum by stepwise tuning of a bandpass filter window for the method according to an exemplary embodiment of an aspect of the invention;

FIG. 7 a comparison of the measured and theoretical backscattered laser spectrum for the method according to an exemplary embodiment of an aspect of the invention; and

FIG. 8 an example of hyperspectral detection with an imaging sensor for the method according to an exemplary embodiment of an aspect of the invention;

FIG. 9 a flowchart of the method for remote analysis of substances according to an exemplary embodiment of an aspect of the invention;

FIG. 10 a mobile sensor system with a detector device for the remote analysis of substances according to an embodiment of an aspect of the invention;

### DETAILED DESCRIPTION

In the figures, components of the same type or acting in the same way are provided with the same reference numeral or sign. The figures only show examples and are not to be understood as limiting.

The directional terminology in the following using terms, such as “left,” “right,” “above,” “below,” “before” “behind,” “after” and the like, is merely intended to make it easier to understand the figures and is by no means intended to constitute a limitation on the overall scope. The components and elements shown, their design and use may vary according to the considerations of a person skilled in the art and can be adapted to the respective applications.

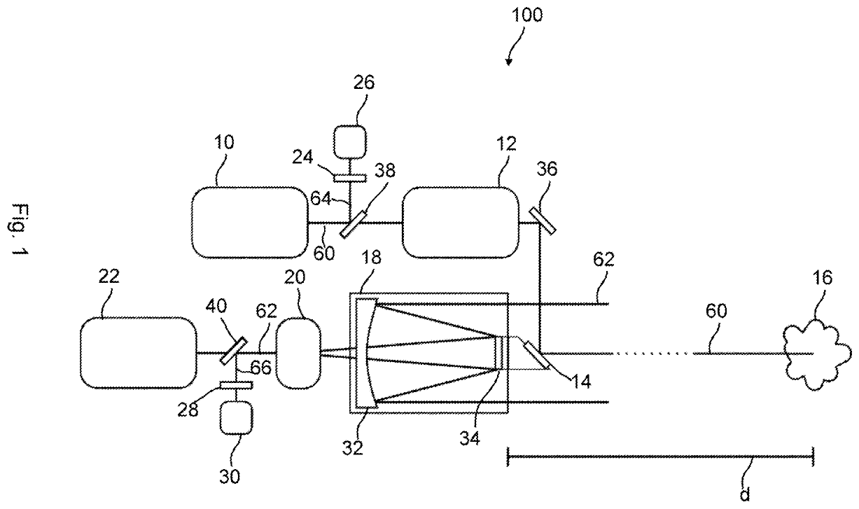

FIG. 1 shows a schematic structure of components of a detector device 100 for remote analysis of substances, in particular hazardous substances, according to an exemplary embodiment of an aspect of the invention.

The detector device 100 includes a laser 10, which is designed to irradiate pulsed laser light 60 onto a sample 16 located at a detection distance d, and a telescope 18 designed to collect and/or focus laser light 62 scattered from the sample 16 and to direct the scattered laser light 62 into an optical spectrometer 22. The optical spectrometer 22 is designed for spectral analysis of the laser light 62 scattered on the sample 16. A first decoupling mirror 38 is provided in the beam path of the laser light 60 for decoupling a first reference beam 64 into a first detector 26. Furthermore, a second decoupling mirror 40 is provided in the beam path of the laser light 62 backscattered from the sample 16 for outputting a second reference beam 66 into a second detector 30. In this case, the detection distance d can be determined in real time from a time difference between pulses of the first reference beam 64 and pulses of the second reference beam 66.

A beam adjustment unit 12 is provided in the beam path of the laser light 60 prior to being decoupled onto the sample 16 via a third decoupling mirror 14, via which a divergence and/or a diameter of the laser beam can be adjusted according to the desired measurement task.

Solid or liquid chemical or biological samples with spatial extent can be detected as sample 16.

A first adjustment optics 24, in particular with a bandpass filter, is provided in the beam path of the first reference beam 64.

The second decoupling mirror 40 is designed as a beam splitter, in particular as a dichroic beam splitter, whereby laser light elastically scattered by the sample 16 is decoupled separately from inelastically scattered Raman light and fluorescence light into the beam path of the second reference beam 66. In the beam path of the second reference beam 66, a second adjustment optics 28, in particular with a bandpass filter and/or a focusing unit, is provided.

The method for remote analysis of substances, in particular hazardous substances, with the detector device 100 comprises the steps of (i) irradiating pulsed laser light 60 onto the sample 16 located at the detection distance d; (ii) decoupling and detecting the first reference beam 64 in the first detector 26; (iii) collecting and/or focusing laser light 62 scattered from the sample 16 into the telescope 18; (iv) decoupling and detecting the second reference beam 66 in the second detector 30; (v) determining the detection distance d in real time from the time difference between pulses of the first reference beam 64 and pulses of the second reference beam 66; (vi) forwarding the scattered laser light 62 to the optical spectrometer 22; (vii) performing a spectral analysis of the laser light 62 scattered from the sample 16 in the spectrometer 22; and (viii) classifying the analyzed laser light 62, in particular classifying the analyzed laser light according to substance classes.

Further, between step (v) and step (vii), the method may comprise further steps of: (v.1) performing a power calibration of the pulsed laser light 60; and (v.2) if the pulsed laser light 60 comprises multiple laser wavelengths, performing an intensity calibration of the pulsed laser light 60.

In order to perform the spectral analysis, the scattered laser light 62 may be filtered using a narrowband filter, in particular a narrowband notch filter. The notch filter is used to suppress elastically scattered laser radiation, which is transmitted from the second decoupling mirror 40 and thus could reach the spectrometer 22. Alternatively, a broadband filter may be used, e.g., in order to cut out only the wavelength range of interest. A wavelength range for the analysis may be selected by means of a narrowband tunable filter and, in particular, continuously tuned.

In the detector device 100, a pulsed laser unit is employed as the laser source 10. The laser 10 is used to excite the sample to be measured. The wavelength is usually selected to be less than 400 nm in the UV range. There are two reasons for this: The proportionality between wavelength and intensity of the backscatter signal is 1/λ⁴, such that a larger backscatter signal is to be expected. In addition, the higher MPI value (maximum permissible irradiation) in the UV range can ensure eye-safe laser intensities. The laser is operated in a pulsed mode. The pulse repetition rate may range from about 1 kHz to 10 MHz, especially to 1 MHz. The greater the repetition rate, the faster the spectrum may be acquired. The pulse width should be smaller than 10 ns, such that the distance can be determined via the laser transit time. In order for the distance to the sample to be determined in real time via transit time measurements of the two reference beams 64, 66, the laser pulse should have a steep rising edge.

A small portion of the light from the beam path of the outgoing laser light 60 is decoupled into the beam path of the first reference beam 64 immediately after the laser output via a first decoupling mirror 38 as a so-called pick-off mirror. By means of an adjustment optics 24, possibly interfering signals which do not originate from the laser are suppressed there, e.g., by means of bandpass filters around the central wavelength of the laser. The filtered light is then focused via a lens onto a fast photodiode as the first detector 26, such that the individual laser pulses can be detected. A typical rise time of the photodiode 26 may be less than 1 ns for this purpose.

The majority of the laser light passes through a beam adjustment unit 12, in which, e.g., the beam diameter or divergence can be adjusted, and is then directed via a third decoupling mirror 14 onto the sample 18 to be examined. Both the elastically backscattered laser light due to Rayleigh scattering and the inelastically scattered spectrally shifted light due to the Raman effect, as well as further contributions due to electronic excitation as fluorescence radiation, are collected by a receiving telescope 18 from a distance from the sample 16, which is referred to as the detection distance d, focused and coupled into a further unit 20 for beam matching. Alternatively, the scattered laser light may be coupled into an optical fiber in order to spatially separate the telescope 18 from the detection optics, i.e., the spectrometer 22.

In the detector device 100 proposed herein, spectral decomposition of the scattered laser light 62 is performed after this beam adjustment unit 20. Using a dichroic beam splitter, a so-called razor edge, as a second decoupling mirror 40, the elastically scattered laser light 62 is reflected into the beam path of the second reference beam 66 and separated from the inelastically scattered Raman light and fluorescence light. In the second reference beam 66, the reflected component first passes through an adjustment optics 28, which also consists of or comprises a bandpass filter around the central wavelength of the laser line and a lens, such that the spectrally cleaned, backscattered laser light can be focused on a second fast photodiode as the second detector 30.

The transmitted portion, including the Raman signal, is coupled into a spectrometer 22 for spectral analysis. A narrow-band notch filter around the laser line is first used to suppress the remaining elastically scattered light. This is followed by a narrowband, fast tunable filter, e.g., a TBPF (Tunable Band Pass Filter) or an AOTF (Acousto Optical Tunable Filter) crystal. The spectrum can subsequently be recorded by electronically scanning the spectral transmission window over the spectral range of interest. For this purpose, detection via a gating window with a very sensitive point sensor, e.g., a PMT (photo multiplier tube), or a camera system, may be used as the imaging sensor.

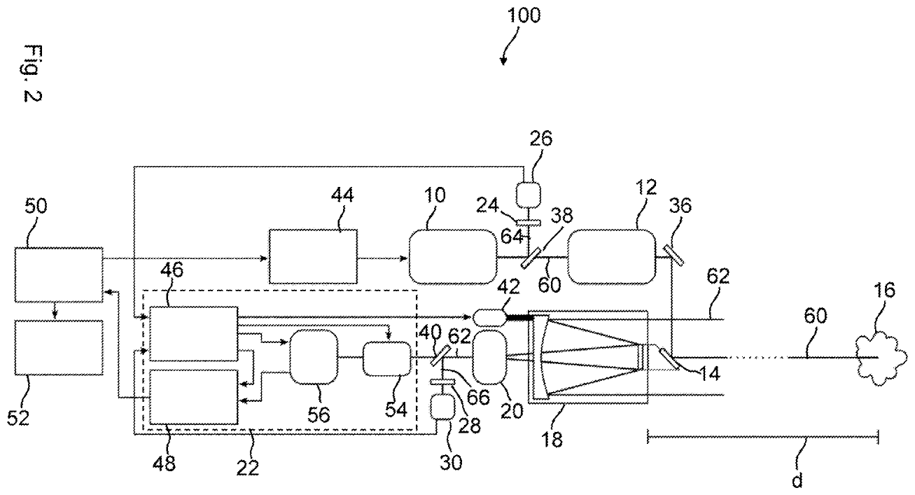

FIG. 2 shows a schematic structure of an overall system of a detector device 100 according to a further exemplary embodiment of an aspect of the invention.

The overall system includes, e.g., other components, such as the computer 50 and classifier 52. which are useful for operating the detector device 100. Furthermore, individual functions of the detector device 100 are split into separate units and converted into additional components, such as control unit, reference unit, measuring unit.

The spectrometer 22 is split into individual components and includes at least a filter module 54, a detector 56, and a measuring unit 48.

In the beam adjustment unit 12, a lens/mirror telescope arrangement is optimally adapted to match the divergence and diameter of the laser beam to the intended application, e.g., low beam expansion over long distances; high laser intensity on the sample; eye-safe laser operation.

The third decoupling mirror 14 enables the adjustment of a collinear or bilinear beam guidance.

The telescope 18 is designed with an autofocus unit 42, which is conveniently controllable by determining the detection distance d. Focusing of the scattered laser light in the beam path 62 from the telescope 18 toward the beam adjustment unit 20 can be performed with the autofocus unit 42, in particular by determining the detection distance d.

The elastically scattered laser light, as well as the inelastically scattered Raman signal are collected via telescope 18, which is used as the receiving telescope. In addition to the Raman signal of interest, interfering and stray light, including elastically scattered laser light, e.g., Rayleigh line, ambient light, sunlight, is also gathered, which can partially distort the useful signal.

A beam adjustment unit 20, in particular with a filter unit, is provided in the beam path 62 of the scattered laser light after the telescope 18. The beam adjustment unit 20 serves as an optional pre-filtering module. The focused backscattered light is coupled into an optical fiber, such that it can be flexibly guided through the fiber to a specific location or recollimated. In order to suppress the Rayleigh line of the excitation laser in advance and reduce interfering signals, a bandpass filter or a longpass filter is used to select the wavelength range of interest.

The filter module 54 may be designed as a tunable filter. A wavelength range of the scattered laser light in the beam path 62 after the telescope 18 can be selected by means of the beam adjustment unit 20, in particular with the filter unit 54. The filter module 54 is designed, such that only a very narrow-band spectral range is transmitted through the filter. For example, an acousto-optic, or electro-optic modulator, or another tunable bandpass filter can be used for this purpose. The spectral window of the filter is tuned successively, until the complete spectrum is covered.

The detector 56 may be designed as a point sensor or an imaging sensor. The detector 56 may be implemented as a point sensor, e.g., a PMT detector, e.g., as a sensitive PMT detector with the ability to perform detection via a gating window. Alternatively, a fast data acquisition card may be used to cut out a window from the complete time track, which is then processed further.

The first matching optic 24 may be a bandpass filter with a window around the central wavelength of the laser, such that only the laser light is transmitted and other contributions are filtered. In addition, this unit includes a lens or a mirror in order to focus the light onto the first detector 26.

The first detector 26 is designed as a fast photodiode with a short rise time and fall time, such that the laser pulses can be resolved in time. The arrival of a laser pulse on the photodiode defines time zero of the measurement.

The second matching optical system 40 may be designed analogously to the first matching optical system 24, and for the second reference beam 66 arranged downstream of the receiving telescope 18.

The second detector 30 may be arranged in the second reference beam 66 analogously to the first detector 26. The second detector 30 is used to measure the laser propagation time and as a variable data acquisition trigger.

Based on the transit time measurement, the detection distance d between the detection system, i.e., the telescope 18, and the sample 16 can be determined. This information can be transmitted in real time to the autofocus unit 42, such that maximum coupling efficiency is always achieved, upon imaging from telescope 18 to beam adjustment unit 20.

After input in the computer 50, the control unit 44 triggers the start of the measurement and the emission of the individual laser pulses.

A reference unit 46 is designed to process signals from the first and second detectors 26, 30, in particular determine the time difference in real time between pulses of the first reference beam 64 and pulses of the second reference beam 66. The reference unit 46 can be used to control the measuring unit 48. Furthermore, the filter module 54, as well as the autofocus unit 42, can be controlled via the reference unit 46.

The unit 46 may further perform, e.g., a power calibration of the pulsed laser light 60 and/or an intensity calibration upon multispectral excitation of the pulsed laser light 60.

The reference unit 46 processes the signals from the first and second detectors 26, 30 via an A/D converter and uses them to determine the laser propagation time and the trigger points. This information is used to determine the gating window of the measuring unit 48, and to trigger by means of a synchronization signal the tunable filter module 54. The laser runtime information controls the autofocus unit 42.

The measurement unit 48 provides a system for reading the measurement data from the point detector 56 and converts the analog electrical signal to a digital signal by means of an AD converter. Subsequently, the boxcar technique is applied by means of appropriate filtering with cut-out signal and background windows, thereby reducing the data rate for further processing. Boxcar averaging of measured values may be realized in the measuring unit 48.

The computer 50 is used for input and control of the detector device 100. Moreover, computer 50 is used for data evaluation and classification.

In classifier 52, the spectra are evaluated and analyzed by a classification algorithm.

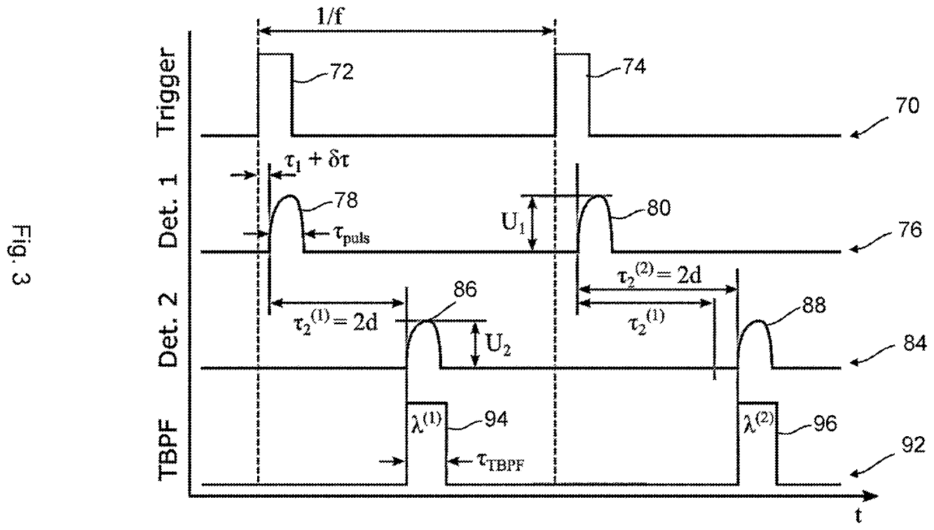

FIG. 3 shows a time-signal waveforms of the method for remote analysis of substances according to an exemplary embodiment of an aspect of the invention. FIG. 3 shows signal waveforms of the trigger signal 70, the signals in the first and second detectors 76, 84, and the signal 92 filtered for the spectrometer 22, as a function of time t. The trigger pulses 72, 74, the detector signals 78, 80 in the first detector 26, the detector signals 86, 88 in the second detector 30, and the filtered signals of the scattered laser light 94, 96 are shown for two consecutive laser pulses. The time interval between the trigger pulses 72, 74 is given by the reciprocal of the pulse repetition frequency f.

As shown in FIG. 3, by using a pulsed laser system, whose laser pulses have a steep rising edge, the detection distance d to the sample 18 can be determined directly in real time with the aid of the two reference beams 64, 66 by measuring the time delay between emission and re-arrival of the laser pulse (laser transit time measurement). Both a time delay τ₁ and a jitter δτ between the trigger, which initiates the emission of a laser pulse, and the emission of the laser pulse do not affect the distance measurement. The only decisive factor is the difference in travel time 12 between the arrival of the laser pulse on the first detector 26 and the second detector 30, which is just twice the detection distance d. The distance is determined with a measurement rate, which is determined solely by the repetition rate of the laser. This has the advantage that the detection distance d to the sample 18 is also determined synchronously with each spectral measurement and an autofocus unit may be readjusted at a maximum speed, which is given by the laser repetition rate. if required.

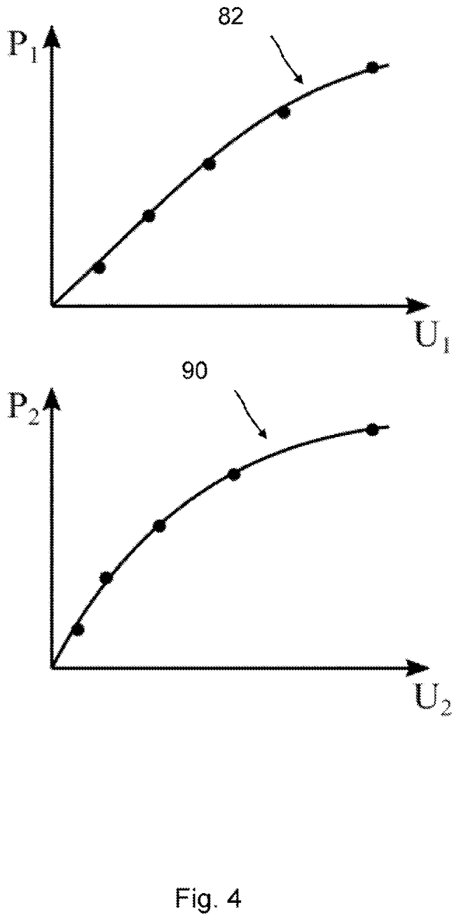

Here, the detector voltages supply further information. FIG. 4 shows typical calibration curves 82, 90 of the first and second detectors 26, 30, as a function of the power P₁, P₂ from the voltage U₁, U₂. With the help of a calibration measurement of the detector device 100, which has to be performed once, the dependence between the laser power emitted onto the sample and the corresponding detector voltage (U₁ or U₂) can be determined for each detector 26, 30. While the first detector 26 only provides information about the emitted laser power, the second detector 30 additionally provides information about the amount of laser power backscattered by the sample 16. In this way, power calibration can be performed. Thus, the ratio between the two calibrated detectors 26, 30 represents a measure of the scattering behavior of sample 16. The factor resulting from the ratio can in turn be used to draw conclusions about the relative strength of the Raman signal, since this depends not only on the properties of the excited molecule, but also on the distance between sample 16 and detector device 100. For excitation with multiple laser wavelengths, this scheme can be extended accordingly: After an initial calibration, it is thus possible to calibrate the different reference beams 64, 66 relative to one another in an intensity calibration in order to obtain further information about the sample and its scattering properties.

The time of arrival of the elastically scattered laser light on the second detector 30 also serves as a variable trigger for the spectrometer 22. The advantage of this arrangement is that the trigger time is automatically shifted in time according to the change in the distance between the detector device 100 and sample 18 (see FIG. 3, i.e., a time shift between the first pulse τ₂⁽¹⁾ and the second pulse τ₂⁽²⁾). When detecting via a gating window, only the measurement window in which a signal is to be expected is analyzed.

Interfering light signals, which provide a continuous background and lower both the usable dynamic range of the detector and thus the signal-to-noise ratio can be effectively suppressed in two ways.

First, a fast tunable bandpass filter (TBPF), whose rise time and fall time are much smaller than the reciprocal of the repetition rate of the laser can be used for spectral analysis. Here, the previously explained advantage of variable trigger timing is exploited. The switching time for the TBPF is determined by the variable trigger, such that light is transmitted through the TBPF only within a defined time interval (τ_{TBTF}≈τₚᵤₗₛₑ<<μsec) in which exactly the measurement signal is also expected (see FIG. 3).

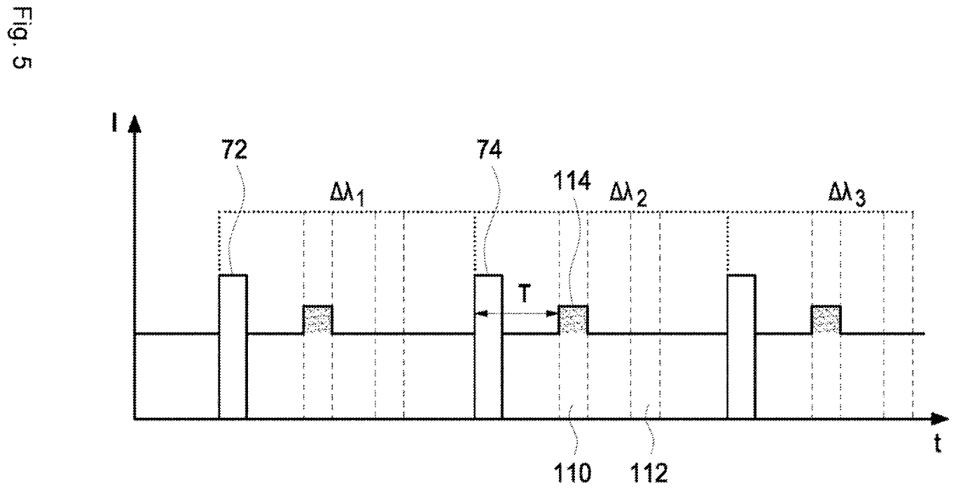

On the other hand, the pulsed operation of the laser 10 allows the boxcar technique to be used. FIG. 5 shows an example of how boxcar averaging is realized in the process according to an exemplary embodiment of an aspect of the invention.

Two different measuring windows are defined here: Signal window 110 and background window 112. In both cases, the signal within the measurement window 110, 112 is integrated. The integral of the signal window 110 is thus composed of or comprises the measurement signal 114 and the background signal. In contrast, with the background window 112, only the integral of the background is obtained. By forming the difference between the two integral values from the two measurement windows 110, 112, the desired, background-free measurement signal 114 is obtained.

When using the boxcar technique, the distance-dependent trigger offers the advantage that the measurement window or the background window automatically shifts according to the sample distance, such that the inelastically scattered Raman signal is always detected in the measurement window, regardless of the distance, resulting in the best possible signal-to-noise ratio.

The metrological implementation of the structure of the detector device 100 according to an aspect of the invention, upon which an aspect of the invention is based, also differs from the previously known, conventional Raman detection systems.

While the classical Raman system uses a spectrometer or a combination of monochromator and detector, in this case a narrowband tunable filter is used, e.g., an acousto-optic or electro-optic tunable filter (AOTF, EOTF)). Analogous to a bandpass filter, a spectrally narrow range is selected based on the detected signal. Only light from this wavelength interval is able to reach the detector. By successively tuning the transmission window of the tunable filter, the complete spectrum can be recorded with high sensitivity, within a short timeframe.

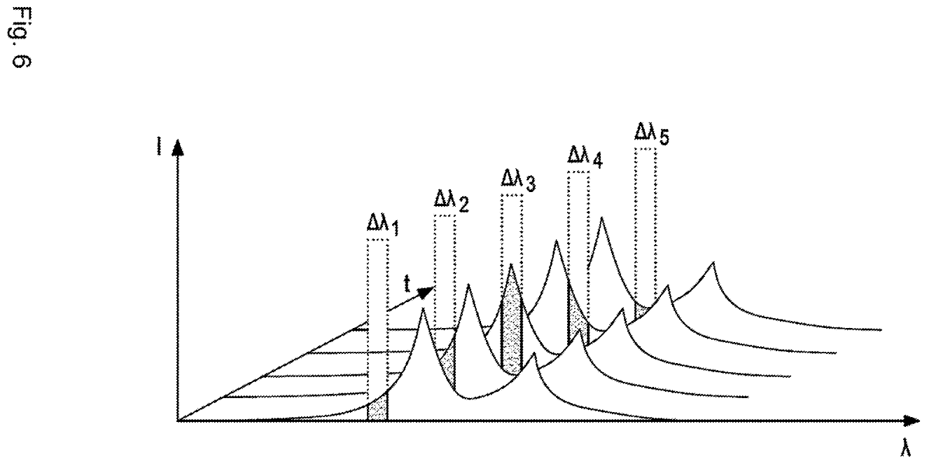

This procedure is illustrated in FIG. 6. FIG. 6 shows an example of scanning the scattered laser spectrum by stepwise tuning of a bandpass filter window, which is used in the method according to an exemplary embodiment of an aspect of the invention. A typical Raman spectrum with an intensity I as a function of the wavelength λ is shown. As a function of time t, a wavelength window Δλᵢ is shifted over the spectrum, shown in FIG. 6 for five discrete instants i=1, . . . 5.

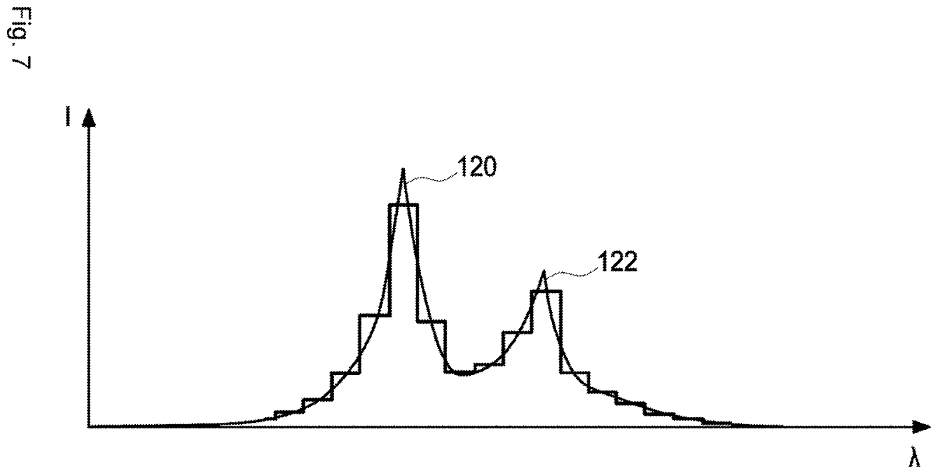

FIG. 7 shows a comparison of the measured and theoretical backscattered laser spectrum of the method according to an exemplary embodiment of an aspect of the invention. The theoretical spectrum is shown as a solid line, and the measured spectrum as a histogram. Peak 120 at lower wavelength λ represents the elastically backscattered portion of the laser light, while peak 122 at higher wavelength represents the inelastically scattered Raman portion of the backscattered laser light. In this case, the measured and theoretical spectrum show very good agreement. With continuous tuning in the spectrometer 22 using a narrowband tunable filter, the measured spectrum becomes continuous and approaches the theoretical spectrum.

The following example, which is valid for both point detection and an imaging system, is intended to demonstrate the time advantage of the method according to an aspect of the invention over the prior art.

The characteristics of an exemplary laser system are as follows: Wavelength: 355 nm, repetition rate: 100 kHz, pulse width: 10 ns.

The Raman wavelength range of interest for subsequent classification of the sample is: 400 cm⁻¹-3,000 cm⁻¹ (which is equivalent to 360 nm-397 nm).

Typical resolution of a tunable AOTF filter is 0.8 nm.

At full resolution (0.8 nm),

$$\frac{400 nm - 360 nm}{0.8 nm} = 50$$

measuring points are required. This can be achieved with a single-shot measurement within a measuring time of

$${T}_{ges} = \frac{50}{100 kHz} = 500 µsec$$

In order to increase the signal-to-noise ratio, several measurements may be performed in succession. If. for example, the maximum possible measuring time is set to Tₘₑₛₛ=1 sec, then

$${\#}_{Wdh} = \frac{{T}_{mess}}{{T}_{ges}} = \frac{1 sec}{500 µsec} = 2000$$

repetitions can be performed.

For comparison: The shortest measurement time of conventional spectrometers is in the range of several milliseconds. in the present example, only 500 usec are required for the recording. Moreover, the proposed method is considerably more sensitive for the same measurement duration.

If a classification is performed after the measurement, there is no need to record the full spectrum. Due to the fast rise and fall times of the tunable filter, the composition of the measurement setup allows here for scanning only over certain spectral windows, if required. The measurement time can thus be reduced even further.

A choice can be made in the detector device according to an aspect of the invention between point detection with high sensitivity or an imaging measuring system. Depending on the requirements, the system can be flexibly adapted.

Very sensitive, fast detectors may be used for point detection. A PMT (photo multiplier tube) detector with gate mode is particularly suitable for this purpose, whereby the sensitivity can be further increased.

However, an imaging sensor in the form of a detector array may also be used as a detector, e.g., a SiPM (Silicon photo multiplier) array, and used in combination with the tunable filter. This allows for the operation of a mapping system. In this case, the sample environment can be spatially recorded and a so-called hyperspectral image is obtained, which contains spectral intensity information.

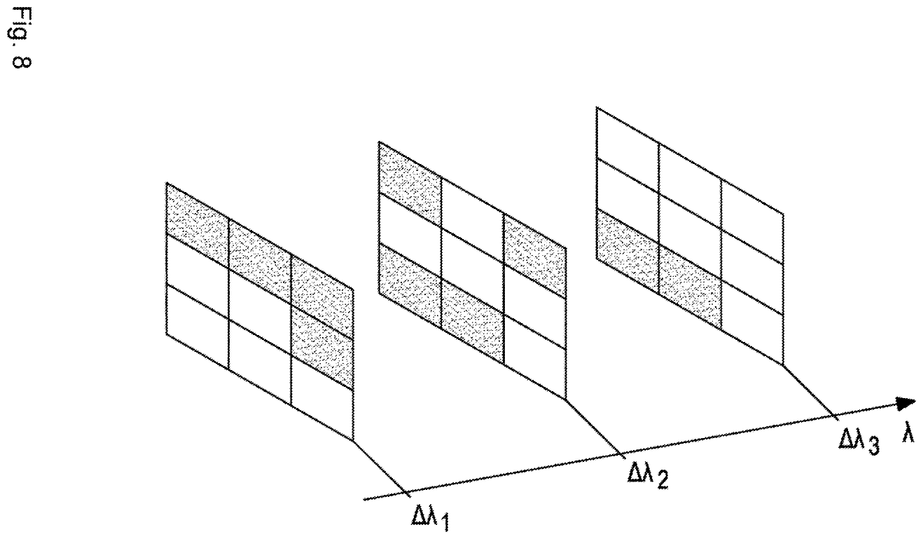

FIG. 8 shows an example of hyperspectral detection with an imaging sensor of the method according to an exemplary embodiment of an aspect of the invention. Here, pixel contents of an imaging sensor for different wavelengths λ are shown schematically. Depending on the wavelength interval Δλᵢ, where 3 different intervals are shown with i=1, 2, 3, the pixels contain different spectral information, illustrated by differently blackened pixels.

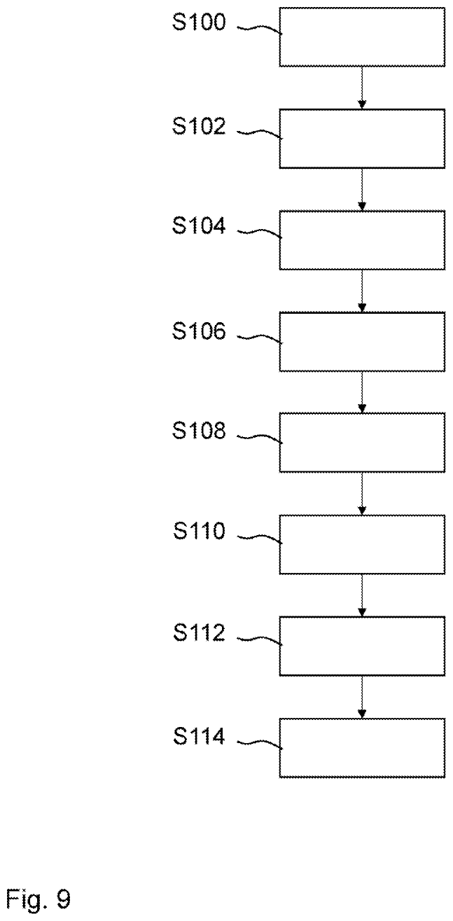

FIG. 9 shows a flowchart of the method for remote analysis of substances according to an exemplary embodiment of an aspect of the invention.

In step S100, pulsed laser light is irradiated onto the sample 16 located at the detection distance d. In step S102, the first reference beam 64 is decoupled and detected in the first detector 26. Step S104 includes collecting and/or focusing laser light scattered from sample 16 into telescope 18. In step S106, the second reference beam 66 is decoupled and detected in the second detector 30. In step S108 the detection distance d is determined in real time based on the time difference between pulses of the first reference beam 64 and pulses of the second reference beam 66. In step S110, the scattered laser light is passed to the optical spectrometer 22, followed a spectral analysis of the laser light scattered from the sample 16 in the spectrometer 22, i.e., step S112. Finally, in step S114, a classification of the analyzed laser light is performed, in particular a classification of the analyzed laser light according to substance classes.

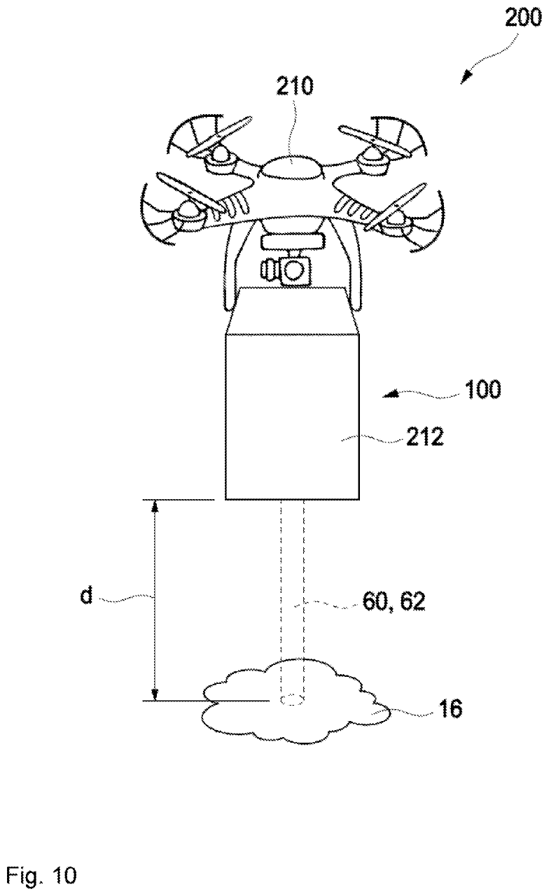

FIG. 10 shows a mobile sensor system 200 with a detector device 100 for the remote analysis of substances, in particular hazardous substances, according to an exemplary embodiment of an aspect of the invention. The mobile sensor system 200 includes an aircraft, in particular a drone 210, with a detector device 100. The detector device 100 is arranged in a housing 212. The housing 212 is arranged below the drone 210 and connected thereto. The laser beam 60 exits at the bottom of the housing 212, and strikes the sample 16 located at the detection distance d and is partially backscattered by it. The backscattered laser light 62 re-enters and is analyzed by the detector device 100 at the bottom of the housing 212. Thus, substance classes of sample 16 can be classified.
10 Laser
12 Beam adjustment unit
14 Decoupling mirror
16 Sample
18 Telescope
20 Beam adjustment unit
22 Spectrometer
24 Adjustment optics
26 Detector 1
28 Adjustment optics
30 Detector 2
32 Concave mirror
34 Secondary mirror
36 Deflection mirror
38 Decoupling mirror
40 Beam splitter
42 Autofocus unit
44 Control unit
46 Reference unit
48 Measuring unit
50 Computer
52 Classifier
54 Filter module
56 Detector
60 Beam path of outgoing laser light
62 Beam path of backscattered laser light
64 First reference beam
66 Second reference beam
70 Trigger signal
72 Trigger pulse 1
74 Trigger pulse 2
76 Signal detector 1
78 Pulse 1
80 Pulse 2
82 Calibration curve
84 Signal detector 2
86 Pulse 1
88 Pulse 2
90 Calibration curve
92 Filter signal
94 Pulse 1
96 Pulse 2
100 Detector device
110 Signal window
112 Background window
114 Measurement signal
120 Elastically scattered laser light
122 Raman fraction
200 Mobile sensor system
210 Drone
212 Housing
d Detection distance

1. A detector device for remote analysis of substances, comprising
at least one laser, which is designed to irradiate pulsed laser light onto a sample located at a detection distance,
a telescope, which is designed to collect and/or focus laser light scattered on the sample and to transmit the scattered laser light into an optical spectrometer, which optical spectrometer is designed for spectral analysis of the laser light scattered on the sample,
wherein the laser is followed by a first beam path with a first reference beam and a further beam path with a second reference beam for the scattered laser light, and a unit is provided for determining a time difference between pulses of the first reference beam and pulses of the second reference beam, wherein the unit is designed to determine the detection distance in real time based on the time difference.

2. The detector device according to claim 1, wherein the unit is designed for power calibration of the pulsed laser light and/or for intensity calibration upon multispectral excitation of the pulsed laser light.

3. The detector device according to claim 1, wherein in the beam path of the emitted laser light, a first decoupling mirror is provided for decoupling the first reference beam into a first detector, and in the beam path of the scattered laser light, a second decoupling mirror is provided for decoupling the second reference beam into a second detector.

4. The detector device according to claim 3, wherein the second decoupling mirror is designed as a dichroic beam splitter, whereby laser light elastically scattered by the sample can be decoupled separately from inelastically scattered Raman light and/or fluorescence light into the beam path of the second reference beam.

5. The detector device according to claim 1, wherein the laser is designed with a maximum wavelength of 400 nm and/or a pulse repetition rate in the range from 1 kHz to 10 MHz and/or a maximum pulse width of 10 ns.

6. The detector device according to claim 1, wherein a first adjustment optics is provided in the beam path of the first reference beam, and/or in that a second adjustment optics is provided in the beam path of the second reference beam.

7. The detector device according to claim 1, wherein the spectrometer has at least one filter module, a detector and a measuring unit, the filter module being designed as a tunable filter, and/or in that the detector is designed as a point sensor or an imaging sensor, and/or in that the measuring unit is designed with boxcar averaging of measured values.

8. The detector device according to claim 1, wherein a beam adjustment unit is provided in the beam path of the laser light before being decoupled onto the sample via a third decoupling mirror (14) and/or in that a beam adjustment unit is provided in the beam path of the scattered laser light after the telescope.

9. The detector device according to claim 1, wherein the telescope is designed with an autofocus unit.

10. The detector device according to claim 1, wherein a reference unit for processing signals of the first and second detector is designed, whereby control of the measuring unit, and/or of the filter module, and/or of the autofocus unit can be achieved.

11. The detector device according to claim 1, wherein a control unit is provided, via which emission of individual laser pulses can be controlled.

12. A mobile sensor system for remote analysis of substances, comprising an unmanned ground vehicle or aircraft with a detector device according to claim 1, wherein the detector device is arranged in a housing, which is connected to the ground vehicle or aircraft.

13. The method for remote analysis of substances, with a detector device according to claim 1, comprising at least the steps of:
irradiating pulsed laser light onto a sample located at a detection distance;
decoupling and detecting a first reference beam in a first detector;
collecting and/or focusing laser light scattered from the sample in a telescope;
decoupling and detecting a second reference beam in a second detector;
determining the detection distance in real time based on a time difference between pulses of the first reference beam and pulses of the second reference beam;
forwarding the scattered laser light to an optical spectrometer;
performing spectral analysis of the laser light scattered from the sample in the spectrometer;
classifying the analyzed laser light.

14. The method according to claim 13, comprising the further steps between step (v) and (vi):
(v.1) performing a power calibration of the pulsed laser light;
(v.2) if the pulsed laser light comprises multiple laser wavelengths, performing an intensity calibration of the pulsed laser light.

15. The method according to claim 13, wherein elastically scattered laser light, which is separated from inelastically scattered Raman light and fluorescence light via the second output coupling mirror as a beam splitter is decoupled into the second detector as a second reference beam.

16. The method according to claim 13, wherein for performing the spectral analysis the scattered laser light is filtered by means of a narrowband filter and/or a wavelength range is selected by means of a tunable filter.

17. The method according to claim 13, wherein laser light having a maximum wavelength of 400 nm and/or a pulse repetition rate in the range from 1 kHz to 10 MHz and/or a maximum pulse of 10 ns is used.

18. The method according to claim 13, wherein the first reference beam is filtered and/or focused before the first detector via first adjustment optics and/or in that the second reference beam is filtered and/or focused before the second detector via second adjustment optics.

19. The method according to claim 13, wherein interfering signals in the scattered laser light are eliminated in the spectrometer, with boxcar averaging of measured values.

20. The method according to claim 13, wherein a divergence and/or a diameter of the laser beam is adjusted by means of a beam adjustment unit (12) before being decoupled onto the sample via a third decoupling mirror (14).

21. The method according to claim 13, wherein a wavelength range of the scattered laser light in the beam path after the telescope is selected by means of a beam adjustment unit wherein focusing of the scattered laser light in the beam path from the telescope toward the beam adjustment unit (20) is controlled with an autofocus unit and wherein the measuring unit, and/or the filter module, and/or the autofocus unit in a reference unit are controlled via the processing of signals from the first and the second detector.

22. The method according to claim 13, wherein a start of a remote analysis of a sample is controlled by means of a control unit 44), in particular after input to a computer (50).

23. A non-transitory software product comprising instructions which, when the software is run on a computer, cause the computer to perform the method of claim 13.
